(19) United States
(12) Patent Application Publication
(10) Pub. No.: US 2014/0118276 A1
(43) Pub. Date: May 1, 2014

(54) TOUCH SYSTEM ADAPTED TO TOUCH CONTROL AND HOVER CONTROL, AND OPERATING METHOD THEREOF

(71) Applicant: PixArt Imaging Inc., Hsin-Chu County (TW)

(72) Inventors: Liang-Chi CHIU, Hsin-Chu (TW); Ming-Tsan KAO, Hsin-Chu (TW)

(73) Assignee: PixArt Imaging Inc., Hsin-Chu County (TW)

(21) Appl. No.: 14/055,166

(22) Filed: Oct. 16, 2013

(30) Foreign Application Priority Data
Oct. 29, 2012 (TW) 101140056

(51) Int. Cl. G06F 3/041; G06F 3/0488

(52) U.S. Cl. CPC G06F 3/0416; G06F 3/04883
USPC 345/173

(57) ABSTRACT

There is provided a touch system adapted to touch control and hover control including a touch sensing device, a hover sensing device and a processing unit. The touch sensing device is configured to sense touch control information. The hover sensing device is configured to sense hover control information. The processing unit is coupled to the touch sensing device and the hover sensing device and configured to activate the hover sensing device when the touch control information indicates a predetermined multi-finger gesture.

### CROSS REFERENCE TO RELATED APPLICATION

This application claims the priority benefit of Taiwan Patent Application Serial Number 101140056, filed on Oct. 29, 2012, the full disclosure of which is incorporated herein by reference.

### BACKGROUND

1. Field of the Disclosure

This disclosure generally relates to a touch system and, more particularly, to a touch system adapted to the touch control and hover control, and an operating method thereof.

2. Description of the Related Art

In the touch operation, a user can correspondingly control the application executed by a display device through touching a touch surface and moving the finger on the touch surface. However under some conditions, it is inconvenient if the user has to touch the touch surface in order to execute the operation. For example when the touch operation cooperates with a display device having a large size screen, it is preferably able to control the display device at a distance from the display device.

For example, FIG. 1 shows a schematic diagram of a touchless user interface for a mobile device disclosed in U.S. Patent Pub. No. 2008010072, in which in order to be adapted to different mobile device the user interface provides a sensory device 200 to be served as an accessory. The sensory device 200 includes at least one appendage 210 for disposing the sensor 220 and a connector 230 for communicating with a mobile device 100. The sensor 220 of the sensory device 200 can form a sensing space 101 above the mobile device 100.

However, as the sensory device 200 is designed for the small screen of the mobile device 100, the finger sensing is implemented by the surface acoustic wave or ultrasonic technology that is suitable to the single point touch at a near distance but not suitable to the multi point touch on a large size screen larger than 30 inches. Furthermore, it is not suitable to the hover operation at a long distance (e.g. more than 15 cm), and thus the use function is greatly limited.

Accordingly, the present disclosure further provides a touch system adapted to touch control and hover control and an operating method thereof that may switch to the hover control by identifying the multi-point gesture detected by a touch sensing device.

### SUMMARY

The present disclosure provides a touch system adapted to touch control and hover control and an operating method thereof that may be adapted to the multi-point touch control and the hover control.

The present disclosure further provides a touch system adapted to touch control and hover control and an operating method thereof that may be applied to the image display device having a large size screen and may perform the hover control at a long distance.

The present disclosure provides a touch system adapted to touch control and hover control including a touch sensing device, a hover sensing device and a processing unit. The touch sensing device is configured to sense touch control information. The hover sensing device is configured to sense hover control information. The processing unit is coupled to the touch sensing device and the hover sensing device and configured to activate the hover sensing device when the touch control information indicates a predetermined multi-finger gesture.

The present disclosure further provides an operating method of a touch system including the steps of: entering a touch control mode when a touch sensing device senses a first touch event; and in the touch control mode, entering a hover control mode when the touch sensing device senses a predetermined multi-finger gesture.

The present disclosure further provides a touch system adapted to touch control and hover control including a touch panel, at least one image sensor and a processing unit. The touch panel is configured to sense at least one finger position. The at least one image sensor is configured to capture an object image. The processing unit is configured to receive touch control information associated with finger position and hover control information associated with the object image, wherein when the touch panel senses a touch event, the touch control information is served as main control information; and when the touch control information indicates a predetermined multi-finger gesture, the hover control information is served as the main control information.

In one aspect, the predetermined multi-finger gesture may be at least three fingers gradually closing and then leaving a touch surface.

In one aspect, the processing unit activates only one of the touch sensing device and the hover sensing device at the same time; or when the hover sensing device is activated and the hover control information is served as main control information, a sensing frequency of the touch sensing device is decreased.

In one aspect, the processing unit is further configured to correspondingly control an image display device according to the touch control information of the touch sensing device or the hover control information of the hover control device.

In one aspect, the touch sensing device includes a capacitive, a resistive or an optical touch panel configured to sense at least one finger position; and the hover sensing device includes at least one image sensor configured to capture an object image.

In the touch system adapted to touch control and hover control and the operating method according to the embodiment of the present disclosure, a processing unit is configured to switch the system operation from a touch control mode to a hover control mode according to a predetermined multi-finger gesture. In the hover control mode, the system operation may be switched from the hover control mode back to the touch control mode according to an object distance or a touch event.

### BRIEF DESCRIPTION OF THE DRAWINGS

Other objects, advantages, and novel features of the present disclosure will become more apparent from the following detailed description when taken in conjunction with the accompanying drawings.

FIG. 1 shows a schematic diagram of the conventional touchless user interface.

FIG. 2 shows a schematic block diagram of the touch system adapted to touch control and hover control according to an embodiment of the present disclosure.

FIG. 3A shows a schematic diagram of the touch system adapted to touch control and hover control according to an embodiment of the present disclosure.

FIG. 3B shows another schematic diagram of the touch system adapted to touch control and hover control according to an embodiment of the present disclosure.

FIGS. 4A-4C show schematic diagrams of a predetermined multi-finger gesture of the touch system according to the embodiment of the present disclosure.

FIG. 5A shows a flow chart of the operating method of the touch system adapted to touch control and hover control according to an embodiment of the present disclosure.

FIG. 5B shows another flow chart of the operating method of the touch system adapted to touch control and hover control according to an embodiment of the present disclosure.

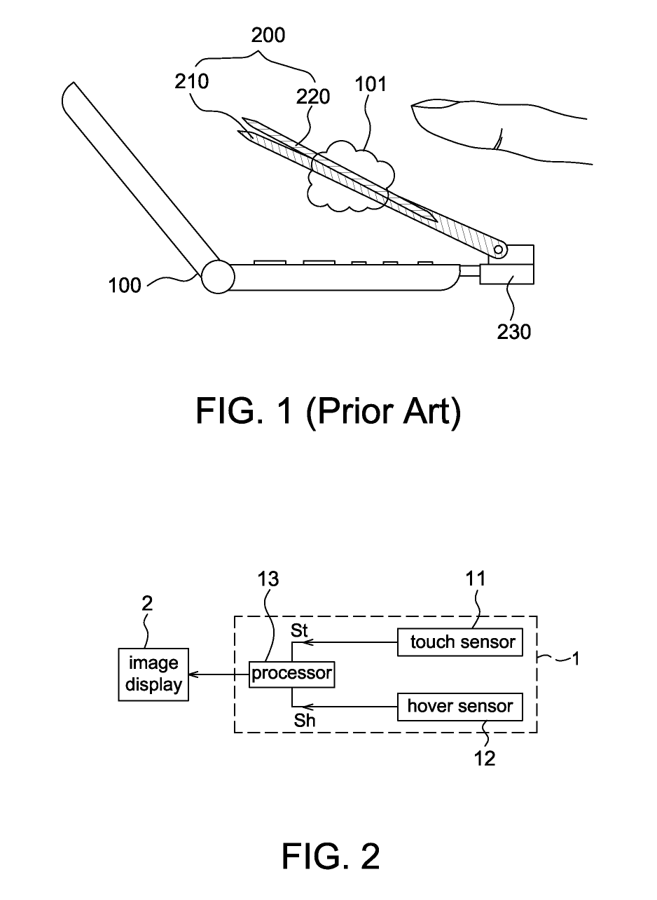

### DETAILED DESCRIPTION OF THE EMBODIMENT

It should be noted that, wherever possible, the same reference numbers will be used throughout the drawings to refer to the same or like parts.

Referring to FIG. 2, it shows a schematic block diagram of the touch system adapted to touch control and hover control according to an embodiment of the present disclosure. The touch system 1 according to the embodiment of the present disclosure includes a touch sensing device 11, a hover sensing device 12 and a processing unit 13, wherein the processing unit 13 receives touch control information St sensed by the touch sensing device 11 and hover control information Sh sensed by the hover sensing device 12, and identifies whether to use the touch control information St of the touch sensing device 11 as main control information or use the hover control information Sh of the hover sensing device 12 as the main control information so as to correspondingly control an image display device 2. The image display device 2 may be a liquid crystal display, a plasma display, a projection device or the like without any limitation, wherein functions executed by an image display device that are controlled according to a touch information or a hovering gesture is well known. The present disclosure is to switch the operation between the touch sensing device 11 and the hover sensing device 12 by the processing unit 13.

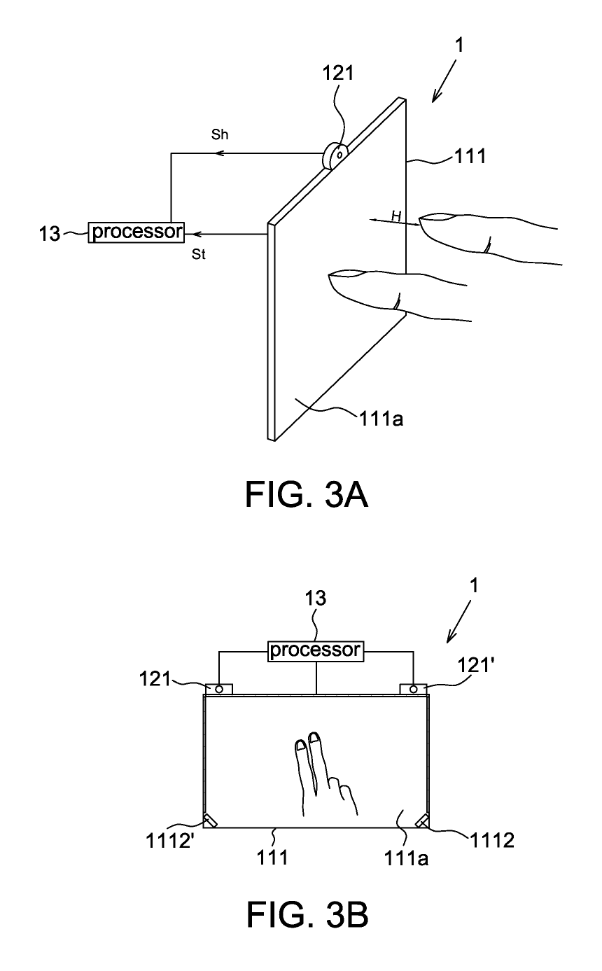

Referring to FIGS. 2 and 3A-3B, FIGS. 3A and 3B show schematic diagrams of the touch system adapted to touch control and hover control according to an embodiment of the present disclosure.

The touch sensing device 11 may include a touch panel 111, e.g. a capacitive, a resistive or an optical touch panel. The touch panel 111 is configured to perform the touch detection on a plane. The touch sensing device 11 senses touch control information St through the touch panel 111 and sends the touch control information St to the processing unit 13 for post-processing, wherein the touch panel 111 included in the touch sensing device 11 may be any suitable panel without any limitation as long as it is able to sense multi-point touch. For example in FIG. 3A, as the touch panel 111 is a capacitive or a resistive touch panel, the touch sensing device 11 does not further include an image sensor; in FIG. 3B, as the touch panel 111 is an optical touch panel, the touch sensing device 11 may further include at least one image sensor (e.g. two image sensors 1112 and 1112′ shown herein) configured to capture image frames looking across a touch surface 111a of the touch panel 111, wherein the number of the image sensors included by the touch sensing device 11 may be determined by the algorithm used by the processing unit 13 for processing the touch control information St without any limitation. An optical touch panel may further include a plurality of strip light sources disposed at edges of the touch surface 111a. The touch control information St may include a touch event, at least one finger position and the variation of the at least one finger position.

The hover sensing device 12 may include at least one image sensor configured to capture an object image, e.g. FIG. 3A showing one image sensor 121 and FIG. 3B showing two image sensors 121 and 121′, wherein the number of the image sensors included in the hover sensing device 12 may be determined by the algorithm used by the processing unit 13 for performing the hover control without any limitation. The hover sensing device 12 may sense hover control information Sh through the object image captured by the at least one image sensor 121 (121′) and send the hover control information Sh to the processing unit 13 for post-processing, wherein said hover control information Sh may include an object distance H (FIG. 3A) and a hovering gesture, which may be a singer-finger gesture or a multi-finger gesture.

The processing unit 13 may be a digital signal processor (DSP) that is coupled to the touch sensing device 11, the touch panel 111, the hover sensing device 12 and the at least one image sensor 121 (121′) so as to respectively receive the touch control information St and the hover control information Sh. For example, the processing unit 13 may receive touch control information St associated with at least one finger position and receive hover control information Sh associated with an object image. When the touch panel 111 of the touch sensing device 11 senses a touch event, the processing unit 13 uses the touch control information St as main control information; and when the touch control information St indicates a predetermined multi-finger gesture, the processing unit 13 activates the hover sensing device 12 and the at least one image sensor 121 (121′) and uses the hover control information Sh as the main control information.

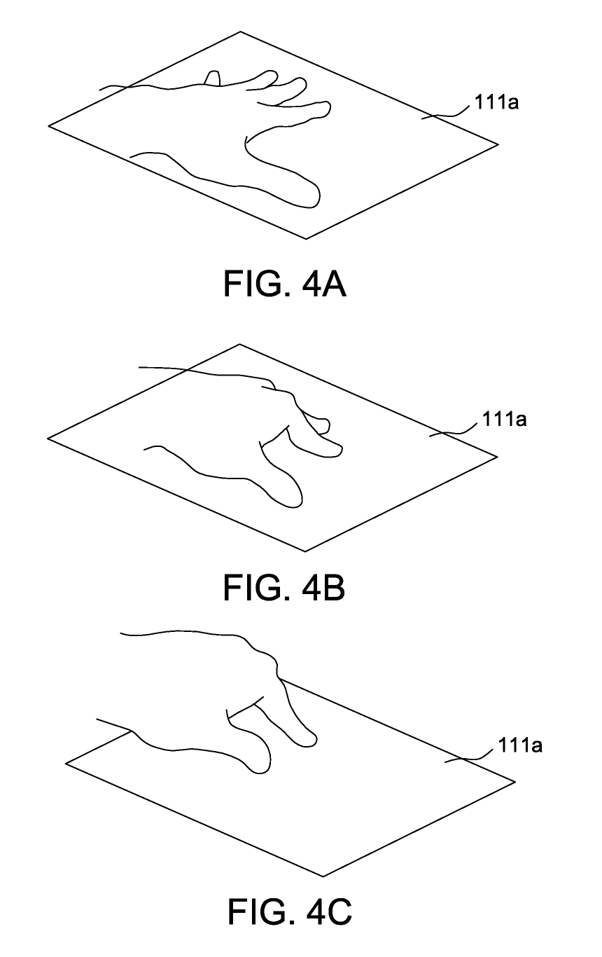

In one embodiment, said predetermined multi-finger gesture may be at least three fingers gradually closing and then leaving a touch surface 111a of the touch panel 111 of the touch sensing device 11. For example referring to FIGS. 4A-4C, they show schematic diagrams of a predetermined multi-finger gesture of the touch system according to the embodiment of the present disclosure, wherein FIG. 4A shows that a user places his or her five fingers spread apart on the touch surface 111a of the touch panel 111; then in FIG. 4B the five fingers gradually closes together; and finally in FIG. 4C the five fingers leave the touch surface 111a to accomplish a complete multi-finger gesture. It is appreciated that in the present disclosure the predetermined multi-finger gesture is not limited to this, and it may be designed according to different applications and previously saved in a memory unit, e.g. other multi-finger gestures may be performed by using 3 fingers, 4 fingers or 5 fingers. The processing unit 13 compares the hover control information Sh with the data saved in the memory unit so as to identify whether the predetermined multi-finger gesture occurs or not.

In one embodiment, when the touch sensing device 11 senses a touch event, the processing unit 13 enters a touch control mode. In the touch control mode, the processing unit 13 may only activate the touch sensing device 11 and process the touch control information St sensed by the touch sensing device 11 and takes the touch control information St as main control information to correspondingly control the image display device 2. Meanwhile, the hover sensing device 12 may be deactivated to avoid wasting unnecessary power.

In another embodiment, when the touch sensing device 11 does not sense a touch event, the processing unit 13 may directly enter a hover control mode. In the hover control mode, the processing unit 13 takes the hover control information Sh as the main control information to correspondingly control the image display device 2, and the touch sensing device 11 may be deactivated or activated continuously (but changing the operation parameter). For example, when the hover control mode is entered, the processing unit 13 activates the at least one image sensor 121 (121′) and decreases a sensing frequency of the touch panel 111 of the touch sensing device 11 so as to sense a touch event at a lower sensing frequency. Or when the hover control mode is entered, the processing unit 13 deactivates the touch sensing device 11 and calculates an object distance H according to the object image captured by the hover sensing device 12 so as to determine whether to activate the touch sensing device 11. For example, when the object distance H is smaller than or equal to a distance threshold, the touch control mode is entered again so as to activate the touch sensing device 11. In one embodiment, when the object distance H is smaller than or equal to a distance threshold, the touch sensing device 11 is activated so as to sense a touch event; and when the touch sensing device 11 senses a touch event, the processing unit 13 enters the touch control mode and deactivates the hover sensing device 12. It is appreciated that in the present disclosure, when the touch sensing device 11 is activated or deactivated, it means that the touch panel 11 is correspondingly activated or deactivated; and when the hover sensing device 12 is activated or deactivated, it means that the at least one image sensor 121 (121′) is correspondingly activated or deactivated.

In a word, in the embodiment of the present disclosure, the processing unit 13 may activate only one of the touch sensing device 11 and the hover sensing device 12 at the same time; or, activate only one of the touch panel 111 and the at least one image sensor 121 (121′) at the same time.

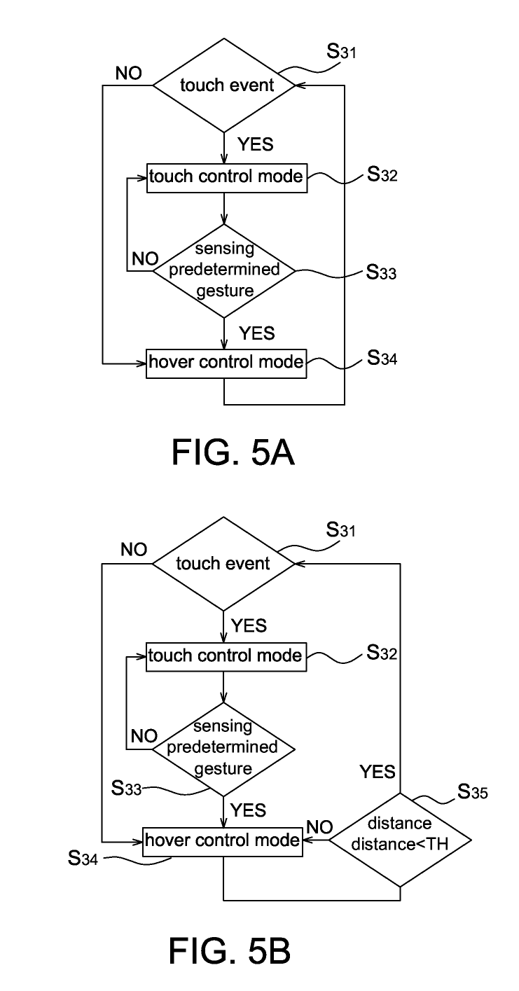

Referring to FIG. 5A, it shows a flow chart of the operating method of the touch system adapted to touch control and hover control according to an embodiment of the present disclosure, which includes the steps of: sensing a touch event (Step S₃₁); entering a touch control mode (Step S₃₂); sensing a predetermined multi-finger gesture (Step S₃₃); and entering a hover control mode (Step S₃₄); wherein in the embodiment of FIG. 5A the touch sensing device 11 is not deactivated when the hover control mode is entered.

Step S₃₁: For example when the system starts to operate, the touch sensing device 11 starts to sense a touch event through the touch panel 111 thereof. When the touch sensing device 11 senses a first touch event, a touch control mode is entered (i.e. Step S₃₂) and the hover sensing device 12 is deactivated; whereas when the touch sensing device 11 does not sense the first touch event, a hover control mode is directly entered (Step S₃₄). In other words, when the touch system 1 according to the embodiment of the present disclosure is activated, the touch sensing device 11 operates at first so as to identify whether a touch event occurs or not; if yes, the touch control mode is entered; if not, the hover control mode is entered.

Step S₃₂: After entering the touch control mode, the processing unit 13 may deactivate the hover sensing device 12 so as to reduce the power consumption. As mentioned above, the processing unit 13 may use the touch control information St sensed by the touch sensing device 11 as the main control information to accordingly control an image display device 12 and sense a predetermined multi-finger gesture simultaneously.

Step S₃₃: In the touch control mode, when the touch sensing device 11 senses a predetermined multi-finger gesture, the hover control mode is entered (Step S₃₄). If the touch sensing device 11 does not sense the predetermined multi-finger gesture, the touch control mode is maintained (Step S₃₂).

Step S₃₄: In the hover control mode, it is able to decrease a sensing frequency of the touch sensing device 11. The processing unit 13 may use the hover control information Sh as the main control information to accordingly control the image display device 2 and identify another touch event according to the touch control information St (i.e. returning to the Step S₃₁). When it is identified that the touch sensing device 11 senses a second touch event, the touch control mode is entered again and the hover control device 12 is deactivated (Step S₃₂); whereas when the second touch event is not sensed, the hover control mode is kept (Step S₃₄).

Referring to FIG. 5B, it shows another flow chart of the operating method of the touch system adapted to touch control and hover control according to an embodiment of the present disclosure, which includes the steps of: sensing a touch event (Step S₃₁); entering a touch control mode (Step S₃₂); sensing a predetermined multi-finger gesture (Step S₃₃); entering a hover control mode (Step S₃₄); and identifying whether an object distance is smaller than a distance threshold (Step S₃₅); wherein the difference between this embodiment and FIG. 5A is that the touch sensing device 11 is deactivated when the hover control mode is entered.

When the touch system 1 of this embodiment enters the hover control mode (Step S₃₄), as the touch sensing device 11 is deactivated, the processing unit 13 is not able to identify a touch event according to the touch control information St. Therefore, the processing unit 13 may further calculate an object distance H according to the object image (as shown in FIG. 3A) and return to the touch control mode when the object distance H is smaller than a distance threshold (Step S₃₂); or the touch sensing device 11 is activated to sense a touch event when the object distance H is smaller than or equal to the distance threshold; and when a touch event is sensed, the touch control mode is entered again. As mentioned above, when the touch control mode is entered, the hover sensing device 12 may be deactivated. However, when the object distance H is larger than the distance threshold, the touch system 1 maintains the hover control mode and continuously disables the touch sensing device 11. It should be mentioned that, the distance threshold may be different according to different applications without any limitation, e.g. determined according to the screen size or the operation space.

The image sensor (e.g. 121, 121′, 1112 and 1112′) in the embodiment of the present disclosure may be the CCD image sensor, CMOS image sensor or other sensing devices capable of sensing image data.

As mentioned above, as the conventional touchless user interface is not suitable for the display device having a large size screen and can only be adapted to the single finger control at a near distance, the applicable range is significantly limited. Therefore, the present disclosure further provides a touch system adapted to touch control and hover control (FIGS. 2, 3A and 3B) and an operating method thereof (FIGS. 5A and 5B) that may be operated in a touch control mode or a hover control mode. The touch system and the operating method of the present disclosure may be applied to the display device having a large size screen and may perform the gesture control at a long distance.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A touch system adapted to touch control and hover control, comprising:
a touch sensing device configured to sense touch control information;
a hover sensing device configured to sense hover control information; and
a processing unit coupled to the touch sensing device and the hover sensing device and configured to activate the hover sensing device when the touch control information indicates a predetermined multi-finger gesture.

2. The touch system as claimed in claim 1, wherein the touch sensing device comprises a capacitive, a resistive or an optical touch panel.

3. The touch system as claimed in claim 1, wherein the predetermined multi-finger gesture is at least three fingers gradually closing and then leaving a touch surface of the touch sensing device.

4. The touch system as claimed in claim 1, wherein the hover sensing device comprises at least one image sensor configured to sense the hover control information.

5. The touch system as claimed in claim 1, wherein the hover sensing device is deactivated when the touch sensing device senses a touch event.

6. The touch system as claimed in claim 1, wherein the processing unit activates only one of the touch sensing device and the hover sensing device at the same time.

7. The touch system as claimed in claim 1, wherein the hover control information comprises an object distance, and the touch sensing device is activated when the object distance is smaller than or equal to a distance threshold.

8. An operating method of a touch system, the touch system comprising a touch sensing device and a hover sensing device, the operating method comprising:
entering a touch control mode when the touch sensing device senses a first touch event; and
in the touch control mode, entering a hover control mode when the touch sensing device senses a predetermined multi-finger gesture.

9. The operating method as claimed in claim 8, wherein the predetermined multi-finger gesture is at least three fingers gradually closing and then leaving a touch surface of the touch sensing device.

10. The operating method as claimed in claim 8, wherein when the touch control mode is entered, the hover sensing device is deactivated; and when the hover control mode is entered, a sensing frequency of the touch sensing device is decreased.

11. The operating method as claimed in claim 8, wherein the hover control mode further comprises: returning to the touch control mode when the touch sensing device senses a second touch event.

12. The operating method as claimed in claim 8, wherein the hover control mode further comprises: returning to the touch control mode when the hover sensing device senses an object distance smaller than a distance threshold.

13. The operating method as claimed in claim 8, further comprising: entering the hover control mode when the touch sensing device does not sense the first touch event.

14. A touch system adapted to touch control and hover control, comprising:
a touch panel configured to sense at least one finger position;
at least one image sensor configured to capture an object image; and
a processing unit configured to receive touch control information associated with finger position and hover control information associated with the object image, use the touch control information as main control information when the touch panel senses a touch event and use the hover control information as the main control information when the touch control information indicates a predetermined multi-finger gesture.

15. The touch system as claimed in claim 14, wherein the touch panel is a capacitive, a resistive or an optical touch panel.

16. The touch system as claimed in claim 14, wherein the predetermined multi-finger gesture is at least three fingers gradually closing and then leaving the touch panel.

17. The touch system as claimed in claim 14, wherein the processing unit activates only one of the touch panel and the at least one image sensor at the same time.

18. The touch system as claimed in claim 14, wherein the hover control information comprises an object distance; and when the object distance is smaller than or equal to a distance threshold, the touch control information is served as the main control information.

19. The touch system as claimed in claim 14, wherein when the processing unit uses the hover control information as the main control information, a sensing frequency of the touch panel is decreased.

20. The touch system as claimed in claim 14, wherein the main control information is configured to control an image display device.
